(19) United States
(12) Patent Application Publication
(10) Pub. No.: US 2024/0232648 A1
(43) Pub. Date: Jul. 11, 2024

(54) MULTIMODAL UNSUPERVISED META-LEARNING METHOD AND APPARATUS

(71) Applicant: ELECTRONICS AND TELECOMMUNICATIONS RESEARCH INSTITUTE, Daejeon (KR)

(72) Inventors: Hyun-Woo KIM, Daejeon (KR); Hwa-Jeon SONG, Daejeon (KR); Jeong-Min YANG, Daejeon (KR); Byung-Hyun YOO, Daejeon (KR); Eui-Sok CHUNG, Daejeon (KR); Ran HAN, Daejeon (KR)

(73) Assignee: ELECTRONICS AND TELECOMMUNICATIONS RESEARCH INSTITUTE, Daejeon (KR)

(21) Appl. No.: 18/537,588

(22) Filed: Dec. 12, 2023

(30) Foreign Application Priority Data
Jan. 5, 2023 (KR) 10-2023-0001532

(51) Int. Cl. G06N 3/0985; G06N 3/0455; G06N 3/088

(52) U.S. Cl. CPC G06N 3/0985; G06N 3/0455; G06N 3/088

(57) ABSTRACT

Disclosed herein are a multimodal unsupervised meta-learning method and apparatus. The multimodal unsupervised meta-learning method includes training, by a multimodal unsupervised feature representation learning unit, an encoder configured to extract features of individual single-modal signals from a source multimodal dataset, generating, by a multimodal unsupervised task generation unit, a source task based on the features of individual single-modal signals, deriving, by a multimodal unsupervised learning method derivation unit, a learning method from the source task using the encoder, and training, by a target task performance unit, a model based on the learning method and features extracted from a small number of target datasets by the encoder, thus performing the target task.

### CROSS REFERENCE TO RELATED APPLICATION

This application claims the benefit of Korean Patent Application No. 10-2023-0001532, filed Jan. 5, 2023, which is hereby incorporated by reference in its entirety into this application.

### BACKGROUND OF THE INVENTION

### 1. Technical Field

The present disclosure relates generally to meta-learning technology for “learning a learning method” with a multimodal dataset without labels.

### 2. Description of the Related Art

Typically, deep learning-based artificial intelligence technology requires massive data with labels and huge computational resources required for training a model. However, it is not easy to acquire massive high quality data which costs a lot of money and time in the real world, and thus there is a difficulty in applying the deep learning-based artificial intelligence technology to many application fields. Accordingly, interest is increasing in meta-learning through which fast learning is possible with a small amount of data by “learning a learning method” to derive a new concept and an efficient learning method.

A dataset of the meta-learning is composed of a source dataset for deriving the concept and learning method, and a target dataset for training a model for a new task through the derived concept and learning method. However, there are disadvantages of massively constructing source datasets with labels in the meta-learning, and thus studies nowadays are performed on an unsupervised meta-learning for finding a concept and learning method from a source dataset without labels.

While a large amount of real-world data is multimodal data such as images, audios, or text, the current unsupervised meta-learning study is limited to single-modal data. Humans handle linguistic information, non-linguistic information (e.g., expression, behavior or the like), or paralinguistic information (e.g., smile, shivering or the like) together and acquire complementary information through concatenation and integration between visual/audible/linguistic intelligence to accurately understand and perform tasks. For example, humans accurately recognize emotion expressed in various ways according to a time, a place, a condition, and an individual by wholly utilizing the multimodal information.

Accordingly, a multimodal unsupervised meta-learning is required to implement artificial intelligence that is similar to human's flexible thinking abilities.

### SUMMARY OF THE INVENTION

Accordingly, the present disclosure has been made keeping in mind the above problems occurring in the prior art, and an object of the present disclosure is to provide a multimodal unsupervised meta-learning apparatus configured to extract conceptual features from a massive multimodal dataset without labels, construct a source task having a type similar to a target task from the source multimodal dataset to derive a learning method for improving learning efficiency and performance, use conceptual features and a learning method to train a model with a small number of target multimodal datasets, and then perform the target task

In accordance with an aspect of the present disclosure to accomplish the above object, there is provided a multimodal unsupervised meta-learning, including training, by a multimodal unsupervised feature representation learning unit, an encoder configured to extract features of individual single-modal signals from a source multimodal dataset, generating, by a multimodal unsupervised task generation unit, a source task based on the features of individual single-modal signals, deriving, by a multimodal unsupervised learning method derivation unit, a learning method from the source task using the encoder, and training, by a target task performance unit, a model based on the learning method and features extracted from a small number of target datasets by the encoder, thus performing the target task.

Training the encoder may include separating, by a signal separator, source multimodal signals sampled from the source multimodal dataset into the individual single-modal signals, determining and masking(hiding), by an adaptive masker, masking positions in the individual single-modal signals using a neural network, inputting, by the encoder, masked signals to the neural network to extract the features, and predicting, by a decoder, a masked portion by means of the neural network based on the features and heterogeneous modal features to recover the signals.

Training the encoder may further include calculating, by a loss calculation and updater, as a loss, a difference between the individual single-modal signals and the recovered signals, similarity of the heterogeneous modal features with temporal consistency, and differentiation of the heterogeneous modal features without temporal consistency, and then updating the encoder, the decoder, and the adaptive masker using the loss.

Generating the source task may include separating, by a signal separator, all source multimodal signals in the source multimodal dataset into the individual single-modal signals, extracting and clustering, by a clusterer, the features of the individual single-modal signals, performing, by a pseudo-labeler, pseudo-labeling on the source multimodal signals based on clustered results of the individual single-modal signals, and selecting, by a task generator, a preset number of pseudo-labels of an arbitrarily selected modal and sampling a preset number of multimodal signals corresponding to the selected pseudo-labels from the source multimodal dataset to repetitively generate a source task composed of a support set and a query set in a format corresponding to the target task.

Deriving the learning method may include separating, by a signal separator, the multimodal signals in a support set and a query set of the source task into the individual single-modal signals, inputting, by a task estimator, the individual single-modal signals to a neural network to estimate a task intended to be performed, modulating, by a task encoding modulator, the encoder based on the estimated task, extracting, by a feature extractor, the features of individual single-modal signals using the modulated encoder, causing, by a feature bottleneck fuser, the extracted single-modal features to share the heterogeneous modal feature information only through a small number of nodes to fuse features in a bottleneck fusion manner, applying, by a feature attention unit, attention to modal knowledge suitable for a context based on the estimated task to weight the features fused in the bottleneck fusion manner, and performing, by a category classifier, category classification based on the weighted features.

Deriving the learning method may further include calculating, by a loss calculation and meta-updater, a loss based on pseudo-labels and updating meta-parameters in the task estimator, the task encoding modulator, the feature extractor, the feature bottleneck fuser, the feature attention unit, and the category classifier.

The meta-parameters of the task estimator, the task encoding modulator, the feature extractor, the feature bottleneck fuser, the feature attention unit, and the category classifier, which are derived with the source task of the source multimodal dataset in the multimodal unsupervised learning method derivation unit, may be used to perform a target task from the multimodal dataset.

The multimodal dataset may include image, audio, and text signals.

The adaptive masker may configure a module using a multilayer convolutional neural network, batch normalization, pooling, and a non-linear function.

Image and audio signals may be input to the module, a multilayer perceptron may be applied to an output of the module to output masking positions, and values corresponding to the masking positions in the image and audio signals may be replaced with 0s to generate masked image and audio signals.

In accordance with another aspect of the present disclosure to accomplish the above object, there is provided a multimodal unsupervised meta-learning apparatus, including memory configured to store a control program for multimodal unsupervised meta-learning, and a processor configured to execute the control program stored in the memory, wherein the processor is configured to train an encoder configured to extract features of individual single-modal signals from a source multimodal dataset, generate a source task based on the features of individual single-modal signals, derive a learning method from the source task using the encoder, and perform the target task by training a model based on the features extracted by the encoder and the learning method.

The processor may be configured to separate source multimodal signals sampled from the source multimodal dataset into the individual single-modal signals, determine and mask (hide) masking positions in the individual single-modal signals using a neural network, input masked signals to the neural network to extract the features, and predict a masked portion by means of the neural network based on the features and heterogeneous modal features to recover the signals.

The processor may be configured to calculate, as a loss, a difference between the individual single-modal signals and the recovered signals, similarity of the heterogeneous modal features with temporal consistency, and differentiation of the heterogeneous modal features without temporal consistency, and then update the encoder, the decoder, and the adaptive masker using the loss.

The processor may be configured to separate all source multimodal signals in the source multimodal dataset into the individual single-modal signals, extract and cluster the features of the individual single-modal signals, perform pseudo-labeling on the source multimodal signals based on clustered results of the individual single-modal signals, and select a preset number of pseudo-labels of an arbitrarily selected modal and sample a preset number of multimodal signals corresponding to the selected pseudo-labels from the source multimodal dataset to repetitively generate a source task composed of a support set and a query set in a format corresponding to the target task.

The processor may be configured to separate the multimodal signals in a support set and a query set of the source task into the individual single-modal signals, input the individual single-modal signals to a neural network to estimate a task intended to be performed, modulate the encoder based on the estimated task, extract the features of individual single-modal signals using the modulated encoder, cause the extracted single-modal features to share the heterogeneous modal feature information only through a small number of nodes to fuse features in a bottleneck fusion manner, apply attention to modal knowledge suitable for a context based on the estimated task to weight the features fused in the bottleneck fusion manner, and perform category classification based on the weighted features.

The processor may be configured to calculate a loss based on pseudo-labels to update meta-parameters.

The processor may be configured to perform the target task from the target multimodal dataset uses the meta-parameters.

The multimodal dataset may include image, audio, and text signals.

The processor may be configured to configure a module using a multilayer convolutional neural network, batch normalization, pooling, a non-linear function, and to determine and mask (hide) masking positions in the individual single-modal signals using the module.

The processor may be configured to input image and audio signals to the module and apply a multilayer perceptron to an output of the module to output masking positions, and to replace values corresponding to the masking positions in the image and audio signals with 0s to generate masked image and audio signals.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating a multimodal unsupervised meta-learning apparatus according to an embodiment;

FIG. 2 is a block diagram illustrating a multimodal unsupervised feature representation learning unit according to an embodiment;

FIG. 3 is a block diagram illustrating a multimodal unsupervised task generation unit according to an embodiment;

FIG. 4 is a block diagram illustrating a multimodal unsupervised learning method derivation unit according to an embodiment;

FIG. 5 is a flowchart illustrating a multimodal unsupervised meta-learning method according to an embodiment; and

FIG. 6 is a block diagram illustrating the configuration of the computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will now be described in detail with reference to the accompanying drawings, identical reference numerals are assigned to indicate identical or similar elements in descriptions made with reference to the drawings, and overlapping descriptions will be omitted.

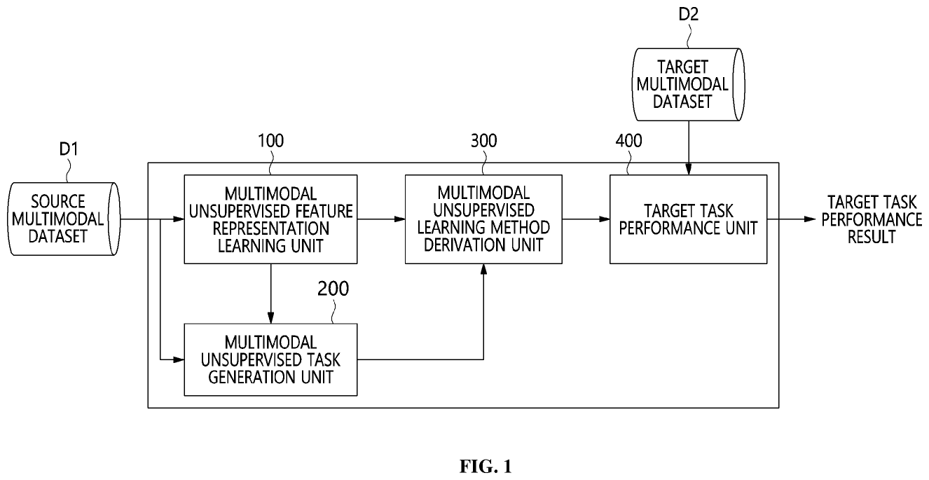

FIG. 1 is a block diagram illustrating a multimodal unsupervised meta-learning apparatus according to an embodiment.

Referring to FIG. 1, the multimodal unsupervised meta-learning apparatus according to an embodiment may include a multimodal unsupervised feature representation learning unit 100, a multimodal unsupervised task generation unit 200, a multimodal unsupervised learning method derivation unit 300 and a target task performance unit 400. Here, the task may refer to an issue intended to address through machine learning or a task intended to perform through machine-learning.

The multimodal unsupervised feature representation learning unit 100 may train an encoder configured to extract the features of individual single-modal signals such as an image, audio, text and the like from a massive source multimodal dataset without labels.

The multimodal unsupervised task generation unit 200 may use the features extracted from the source multimodal dataset by the trained encoder to generate a source task having a type similar to a target task.

The multimodal unsupervised learning method derivation unit 300 may use the trained encoder to derive, from the generated source task, a learning method for improving the training efficiency and performance.

The target task performance unit 400 may use the features extracted from a small number of target datasets by the encoder and the derived learning method to train the model to perform the target task.

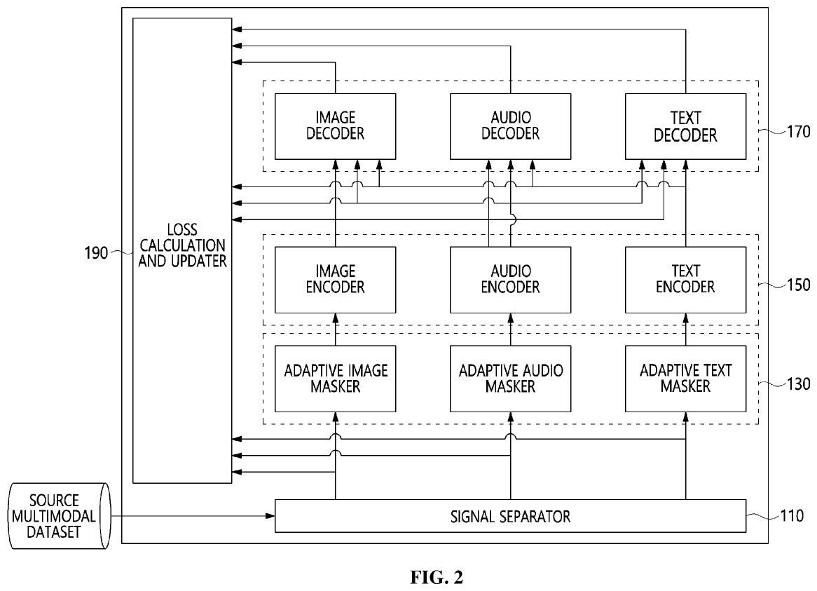

FIG. 2 is a block diagram illustrating a multimodal unsupervised feature representation learning unit according to an embodiment.

Referring to FIG. 2, the multimodal unsupervised feature representation learning unit 100 according to an embodiment may include a signal separator 110, an adaptive masker 130, an encoder 150, a decoder 170, and a loss calculation and updater 190.

The signal separator (a first signal separator 110) may separate source multimodal signals sampled from the source multimodal dataset into individual single-modal signals such as an image, audio, text and the like.

The adaptive masker 130 may include an adaptive image masker, an adaptive audio masker, and an adaptive text masker.

The adaptive masker 130 may receive an image/audio/text signal to determine masking positions in the image/audio/text signal by means of a neural network and mask the image/audio/text signal.

For example, the adaptive image/audio masker may use a multiple-layer convolutional neural network-batch normalization-pooling-nonlinear function to configure a module, input image/audio signal as a module input, apply a multi-layer perceptron to the module output, and replace, with 0s, values corresponding to the masking positions in the image/audio signal to generate masked image/audio signals.

The neural network is a term including various types of machine-learning models designed by imitating the neural structure. For example, the neural network may include various types of neural network-based models such as an artificial neural network (ANN), a convolutional neural network (CNN) or the like.

The encoder 150 may include an image encoder, an audio encoder, and a text encoder.

The encoder 150 may receive the masked image/audio/text signals and extract image/audio/text features. For example, the image/audio encoder divides the masked signals into a plurality of patches, changes each of the patches into one-dimension and then performs linear conversion thereon, and adds a position embedding vector to the linear-converted patches to configure a sequence of the patches. Then, a [CLS] token is attached to the sequence to be input to a transformer encoder, and an output of the transformer encoder may be used as the image/audio feature.

The decoder 170 may include an image decoder, an audio decoder, and a text decoder.

The decoder 170 uses together heterogeneous modal features from the extracted image/audio/text feature to predict a masked portion by means of a simple neural network to recover the image/audio/text signal. For example, the image/audio decoder inputs the image/audio feature extracted by the transformer encoder to the transformer decoder, and performs cross attention with the heterogeneous feature to recover the image/audio signal.

The loss calculation and updater 190 may calculate, as a loss, the difference between an original signal and a recovered signal of the image/audio/text, the similarity of the heterogeneous modal features with temporal consistency, and the differentiation of the heterogeneous modal features without temporal consistency, and then use the loss to update the image/audio/text encoder, the image/audio/text decoder, and the adaptive image/audio/text masker.

For example, the difference between the original signal and the recovered signal is calculated with the Euclidean distance. In addition, the output of the transformer encoder, which corresponds to the [CLS] token position, may pass through a converter, which uses the multi-layer perceptron that reduces a spatial feature difference, to acquire a potential representation of an individual single-modal.

The similarity may be measured with a cosine similarity of the potential representation of the image, audio, or text extracted from the video in the same time frame, and the differentiation may be measured by taking a negative value on the cosine similarity of the potential representation of the image, audio, or text extracted in different time frames.

The gradient of the loss may be calculated, and the image/audio/text encoder, the image/audio/text decoder, and the adaptive image/audio/text masker may be updated with a stochastic gradient descent method.

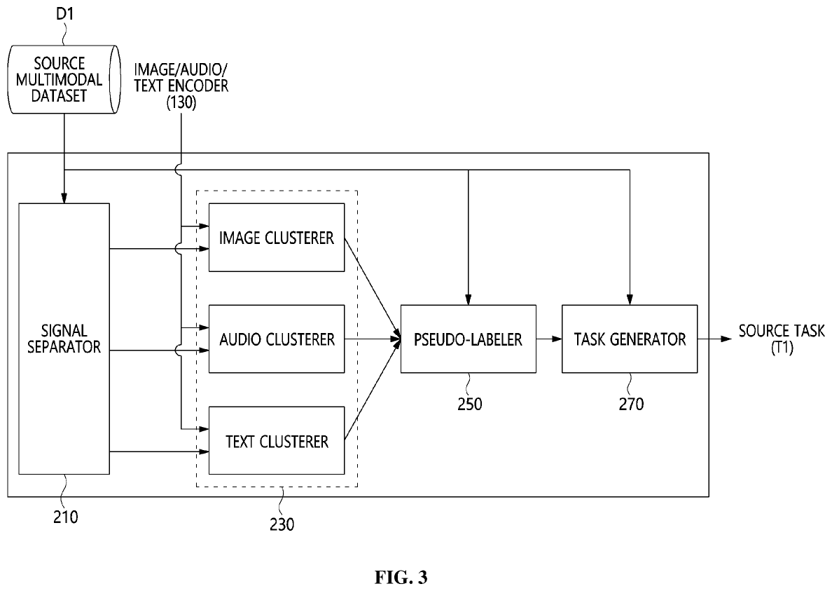

FIG. 3 is a block diagram illustrating a multimodal unsupervised task generation unit according to an embodiment.

Referring to FIG. 3, the multimodal unsupervised task generation unit 200 may include a signal separator 210, a clusterer 230, a pseudo-labeler 250, and a task generator 270.

The signal separator (a second signal separator 210) may separate source multimodal signals sampled from the source multimodal dataset into individual signal modal signals such as an image, audio, text and the like.

The clusterer 230 may include an image clusterer, an audio clusterer, and a text clusterer.

The clusterer 230 may use the image/audio/text encoder 150 to extract the image, audio and text features from the separated image, audio and text signals of the source multimodal dataset D1, and cluster the extracted features. For example, the clustering may be performed through the K-means algorithm.

The pseudo-labeler 250 may use the individual image, audio and text clustering results to perform pseudo-labeling on all the multimodal signals of the source multimodal dataset D1. For example, the multimodal signals may be pseudo-labeled with indexes corresponding to the nearest center among the centers of the clusters of which the image, audio, and text features are respectively acquired through the K-means algorithm.

The task generator 270 may arbitrarily select a modal, selects a preset number of the pseudo-labels of the selected modal, and perform sampling the preset number of the multimodal signals corresponding to the pseudo-labels selected from the source multimodal dataset to repetitively generate the source task T1 composed of a support set and a query set having the same type as the target task.

For example, it is assumed that the source multimodal dataset D1 is pseudo-labeled with total 100 categories. If it is assumed that an image is selected as an arbitrary modal when making the source multimodal task having 5 categories and one example for each of the categories, arbitrary 5 pseudo-labels may be selected from among 100 pseudo-labels labeled as an image feature, arbitrary two are sampled from a lot of source multimodal data having the selected pseudo-labels, and a support set and a query set may be allocated to one piece of the sampled source multimodal data to generate the source task T1.

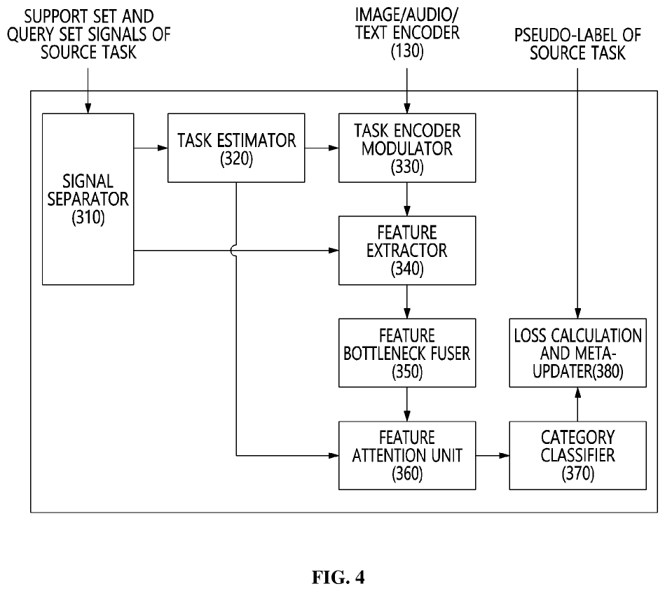

FIG. 4 is a block diagram illustrating a multimodal unsupervised learning method derivation unit according to an embodiment.

As illustrated in FIG. 4, the multimodal unsupervised learning method derivation unit 300 according to an embodiment may include a signal separator 310, a task estimator 320, a task encoding modulator 330, a feature extractor 340, a feature bottleneck fuser 350, a feature attention unit 360, a category classifier 370, and a loss calculation and meta-updater 380.

The signal separator (a third signal separator 310) may separate the multimodal signals in the support set and query set of the source task into individual single-modal signals such as an image, audio, and text or the like.

The task estimator 320 may input the image, audio, and text signals of the support set and query set to a neural network to estimate a task intended to perform. For example, the multiple-layer convolutional neural network-batch normalization-pooling-nonlinear function is used to configure a lower layer module, and an upper layer module is composed of a two-layer bidirectional long-term and short-term memory neural network in order to consider the correlation between the inputs. The image and audio signals except for the text signal are input to the module, and then an embedding vector indicating the task may be acquired as a module output.

The task encoding modulator 330 uses the estimated task to modulate the model of the image/audio/text encoder. For example, the estimated task is input to the multilayer perceptron, and scales and biases are calculated as the output in order to modulate parameters of the task encoder. The multimodal unsupervised feature representation learning unit 100 may multiply the acquired parameters of the image/audio/text encoder 150 by the scales and add the biases thereto to acquire the modulated task encoder.

The feature extractor 240 may use the modulated task encoder to extract the image, audio, and text signal features of the support set and the query set. For example, the image/audio encoder divides the masked signals to a plurality of patches, changes each of the patches into one-dimension and then performs linear conversion thereon, and adds a position embedding vector to the linear-converted patches to configure a sequence of patches. The sequence may be input to the modulated encoder, and the output of the modulated encoder may be used as the image and audio features. Meanwhile, the well-known pre-trained model BERT may be used to extract the text features.

The feature bottleneck fuser 350 may fuse the image, audio, and text features in a bottleneck fusion manner by causing the individual modal features of the image, audio, and text to share heterogeneous feature information only through some nodes (a small number of nodes). For example, the individual modal features of the sequential image, audio, and text are concatenated with separate sharable node features to make a new sequence to be passed through a multilayer transformer. Then, the image features do not directly refer to the audio features, but the separate node features concatenated with the audio features may indirectly refer to information obtained while passing through the transformer.

The feature attention unit 360 uses the estimated task to apply the attention to modal knowledge suitable for a context and thus weighs the features fused in a bottleneck fusion manner. For example, emotion is expressed in various ways according to a time, a place, a situation, or an individual, and thus the time, the place, the situation, or the individual is figured out through the task features estimated from the support set of the source task, and a modal to be attentive may be softly selected.

The category classifier 370 uses the weighted features to perform category classification. For example, the weighted features may be input to the multilayer perceptron to perform the category classification.

The loss calculation and meta-updater 380 may use the pseudo-labels to calculate the loss, and update meta-parameters in the task estimator, the task encoding modulator, the feature extractor, the feature bottleneck fuser, the feature attention unit, and the category classifier. The meta-parameters are initial values, a learning rate, and a learning director vector of the model parameters, For example, a method-agnostic meta-learning (MAML) method may be used.

The loss calculation and meta-updater 380 measures cross entropy for a label predicted by performing the task with the support set of the source task and the pseudo-label of the support set, and internally updates the feature extractor 340, the feature bottleneck fuser 350, and the category classifier 370 with the stochastic gradient descent method.

The loss calculation and meta-updater 380 may include an internally updated model by receiving the query set of the source task to measure the cross entropy for the label predicted by performing the task and the pseudo-label of the query set, and update initial values of the task estimator 320, the task encoding modulator 330, and the feature extractor 340, and the initial values of the model, which are the meta-parameters of the feature bottleneck fuser 350, the feature attention unit 360, and the category classifier 370.

Returning to FIG. 1, the target task performance unit 400 uses the meta-parameters of the task estimator 320, the task encoding modulator 330, and the feature extractor 340, the feature bottleneck fuser 350, the feature attention unit 360, and the category classifier 370, which are derived by the source task of the source multimodal dataset, to perform the target task from the target multimodal dataset.

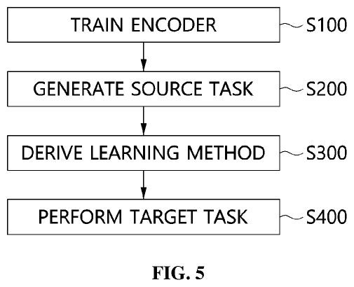

FIG. 5 is a flowchart illustrating a multimodal unsupervised meta-learning method according to an embodiment.

As illustrated in FIG. 5, the multimodal unsupervised meta-learning method according to an embodiment may include step S100 of training an encoder, step S200 of generating a source task, step S300 of deriving a learning method, and step S400 of performing a target task. The multimodal unsupervised meta-learning method according to the embodiment may be performed in the multimodal unsupervised meta-learning apparatus according to the embodiment.

The multimodal unsupervised meta-learning apparatus may train the encoder configured to extract the features of individual single-modal signals from the source multimodal dataset at step S100.

The multimodal unsupervised meta-learning apparatus may generate the source task based on the features of the individual single-modal signals at step S200.

The multimodal unsupervised meta-learning apparatus may use the encoder to derive a learning method from the source task at step S300.

The multimodal unsupervised meta-learning apparatus may train the model based on the learning method and the features extracted from a small number of target datasets by the encoder to perform the target task at step S400.

The multimodal unsupervised meta-learning apparatus according to the embodiment may be implemented in a computer system such as a computer-readable storage medium.

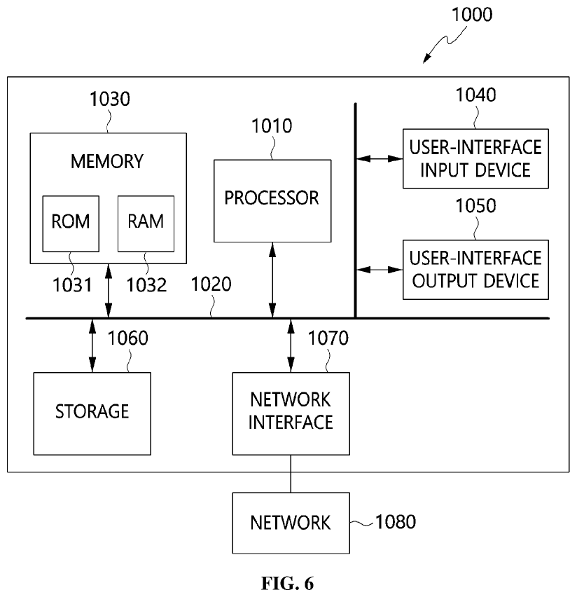

FIG. 6 is a block diagram illustrating the configuration of the computer system according to an embodiment.

Referring to FIG. 6, a computer system 1000 according to an embodiment may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the multimodal unsupervised meta-learning apparatus.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The memory 1030 may store various types of data for the overall operation such as a control program for performing a multimodal unsupervised meta-learning method according to an embodiment. In detail, the memory 1030 may store multiple applications executed by the multimodal unsupervised meta-learning apparatus, and data and instructions for the operation of the multimodal unsupervised meta-learning apparatus.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

In accordance with an embodiment, there can be provided a computer-readable storage medium for storing a computer program, which may include instructions enabling the processor to perform a method including an operation of training an encoder configured to extract features of individual single-modal signals from a source multimodal dataset, an operation of generating a source task based on the features of individual single-modal signals, an operation of deriving a learning method from the source task using the encoder, and an operation of training a model based on the learning method and features extracted from a small number of target datasets by the encoder, thus performing the target task.

In accordance with an embodiment, there can be provided a computer program stored in a computer-readable storage medium, which may include instructions enabling the processor to perform a method including an operation of training an encoder configured to extract features of individual single-modal signals from a source multimodal dataset, an operation of generating a source task based on the features of individual single-modal signals, an operation of deriving a learning method from the source task using the encoder, and an operation of training a model based on the learning method and features extracted from a small number of target datasets by the encoder, thus performing the target task.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

In accordance with the present disclosure having the above configuration, the embodiments combine the meta-learning and the unsupervised learning to derive the concept and learning method from the source data without labels to enable fast learning with a small amount of target data, and thus may relax constraints for the massive data with labels and calculation resources and make it possible to apply the technology to various fields even with a small amount of data to accordingly allow the extension of application range of the artificial intelligence.

In addition, according to the embodiments, the multimodal unsupervised meta-learning technology, which handles linguistic, unlinguistic, paralinguistic information, may improve task performance in comparison to the existing technology by accurately understanding tasks through complementary information resulting from concatenation and integration between visual/audible/linguistic intelligence.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A multimodal unsupervised meta-learning method, comprising:
training, by a multimodal unsupervised feature representation learning unit, an encoder configured to extract features of individual single-modal signals from a source multimodal dataset;
generating, by a multimodal unsupervised task generation unit, a source task based on the features of individual single-modal signals;
deriving, by a multimodal unsupervised learning method derivation unit, a learning method from the source task using the encoder; and
training, by a target task performance unit, a model based on the learning method and features extracted from a small number of target datasets by the encoder, thus performing the target task.

2. The multimodal unsupervised meta-learning method of claim 1, wherein training the encoder comprises:
separating, by a signal separator, source multimodal signals sampled from the source multimodal dataset into the individual single-modal signals;
determining and masking, by an adaptive masker, masking positions in the individual single-modal signals using a neural network;
inputting, by the encoder, masked signals to the neural network to extract the features; and
predicting, by a decoder, a masked portion by means of the neural network based on the features and heterogeneous modal features to recover the signals.

3. The multimodal unsupervised meta-learning method of claim 2, wherein training the encoder further comprises:
calculating, by a loss calculation and updater, as a loss, a difference between the individual single-modal signals and the recovered signals, similarity of the heterogeneous modal features with temporal consistency, and differentiation of the heterogeneous modal features without temporal consistency, and then updating the encoder, the decoder, and the adaptive masker using the loss.

4. The multimodal unsupervised meta-learning method of claim 1, wherein generating the source task comprises:
separating, by a signal separator, all source multimodal signals in the source multimodal dataset into the individual single-modal signals;
extracting and clustering, by a clusterer, the features of the individual single-modal signals;
performing, by a pseudo-labeler, pseudo-labeling on the source multimodal signals based on clustered results of the individual single-modal signals; and
selecting, by a task generator, a preset number of pseudo-labels of an arbitrarily selected modal and sampling a preset number of multimodal signals corresponding to the selected pseudo-labels from the source multimodal dataset to repetitively generate a source task composed of a support set and a query set in a format corresponding to the target task.

5. The multimodal unsupervised meta-learning method of claim 1, wherein deriving the learning method comprises:
separating, by a signal separator, the multimodal signals in a support set and a query set of the source task into the individual single-modal signals;
inputting, by a task estimator, the individual single-modal signals to a neural network to estimate a task intended to be performed;
modulating, by a task encoding modulator, the encoder based on the estimated task;
extracting, by a feature extractor, the features of individual single-modal signals using the modulated encoder;
causing, by a feature bottleneck fuser, the extracted single-modal features to share the heterogeneous modal feature information only through a small number of nodes to fuse features in a bottleneck fusion manner;
applying, by a feature attention unit, attention to modal knowledge suitable for a context based on the estimated task to weight the features fused in the bottleneck fusion manner; and
performing, by a category classifier, category classification based on the weighted features.

6. The multimodal unsupervised meta-learning method of claim 5, wherein deriving the learning method further comprises:
calculating, by a loss calculation and meta-updater, a loss based on pseudo-labels and updating meta-parameters in the task estimator, the task encoding modulator, the feature extractor, the feature bottleneck fuser, the feature attention unit, and the category classifier.

7. The multimodal unsupervised meta-learning method of claim 6, wherein the meta-parameters of the task estimator, the task encoding modulator, the feature extractor, the feature bottleneck fuser, the feature attention unit, and the category classifier, which are derived with the source task of the source multimodal dataset in the multimodal unsupervised learning method derivation unit, are used to perform a target task from the multimodal dataset.

8. The multimodal unsupervised meta-learning method of claim 1, wherein the multimodal dataset includes image, audio, and text signals.

9. The multimodal unsupervised meta-learning method of claim 2, wherein the adaptive masker configures a module using a multilayer convolutional neural network, batch normalization, pooling, and a non-linear function.

10. The multimodal unsupervised meta-learning method of claim 9, wherein image and audio signals are input to the module, a multilayer perceptron is applied to an output of the module to output masking positions, and values corresponding to the masking positions in the image and audio signals are replaced with 0s to generate masked image and audio signals.

11. A multimodal unsupervised meta-learning apparatus, comprising:
a memory configured to store a control program for multimodal unsupervised meta-learning; and
a processor configured to execute the control program stored in the memory,
wherein the processor is configured to train an encoder configured to extract features of individual single-modal signals from a source multimodal dataset, generate a source task based on the features of individual single-modal signals, derive a learning method from the source task using the encoder, and perform the target task by training a model based on the features extracted by the encoder and the learning method.

12. The multimodal unsupervised meta-learning apparatus of claim 11, wherein the processor is configured to separate source multimodal signals sampled from the source multimodal dataset into the individual single-modal signals, determine and mask masking positions in the individual single-modal signals using a neural network, input masked signals to the neural network to extract the features, and predict a masked portion by means of the neural network based on the features and heterogeneous modal features to recover the signals.

13. The multimodal unsupervised meta-learning apparatus of claim 12, wherein the processor is configured to calculate, as a loss, a difference between the individual single-modal signals and the recovered signals, similarity of the heterogeneous modal features with temporal consistency, and differentiation of the heterogeneous modal features without temporal consistency, and then update the encoder, the decoder, and the adaptive masker using the loss.

14. The multimodal unsupervised meta-learning apparatus of claim 11, wherein the processor is configured to separate all source multimodal signals in the source multimodal dataset into the individual single-modal signals, extract and cluster the features of the individual single-modal signals, perform pseudo-labeling on the source multimodal signals based on clustered results of the individual single-modal signals, and select a preset number of pseudo-labels of an arbitrarily selected modal and sample a preset number of multimodal signals corresponding to the selected pseudo-labels from the source multimodal dataset to repetitively generate a source task composed of a support set and a query set in a format corresponding to the target task.

15. The multimodal unsupervised meta-learning apparatus of claim 11, wherein the processor is configured to separate the multimodal signals in a support set and a query set of the source task into the individual single-modal signals, input the individual single-modal signals to a neural network to estimate a task intended to be performed, modulate the encoder based on the estimated task, extract the features of individual single-modal signals using the modulated encoder, cause the extracted single-modal features to share the heterogeneous modal feature information only through a small number of nodes to fuse features in a bottleneck fusion manner, apply attention to modal knowledge suitable for a context based on the estimated task to weight the features fused in the bottleneck fusion manner, and perform category classification based on the weighted features.

16. The multimodal unsupervised meta-learning apparatus of claim 15, wherein the processor is configured to calculate a loss based on pseudo-labels to update meta-parameters.

17. The multimodal unsupervised meta-learning apparatus of claim 16, wherein the processor is configured to perform the target task from the target multimodal dataset uses the meta-parameters.

18. The multimodal unsupervised meta-learning apparatus of claim 11, wherein the multimodal dataset includes image, audio, and text signals.

19. The multimodal unsupervised meta-learning apparatus of claim 12, wherein the processor is configured to configure a module using a multilayer convolutional neural network, batch normalization, pooling, a non-linear function, and to determine and mask masking positions in the individual single-modal signals using the module.

20. The multimodal unsupervised meta-learning apparatus of claim 19, wherein the processor is configured to input image and audio signals to the module, apply a multilayer perceptron to an output of the module to output masking positions, and replace values corresponding to the masking positions in the image and audio signals with 0s to generate masked image and audio signals.
